(19) United States
(12) Patent Application Publication
(10) Pub. No.: US 2011/0134204 A1
(43) Pub. Date: Jun. 9, 2011

(54) SYSTEM AND METHODS FOR FACILITATING COLLABORATION OF A GROUP

(75) Inventors: Walter Rodriguez, Bonita Springs, FL (US); Augusto Opdenbosch, Alpharetta, GA (US); Deborah S. Carstens, Melbourne, FL (US); Brian Goldiez, Orlando, FL (US); Stephen M. Fiore, Orlando, FL (US); Veton Kepuska, Melbourne, FL (US)

(73) Assignee: FLORIDA GULF COAST UNIVERSITY, Ft. Myers, FL (US)

(21) Appl. No.: 12/746,119

(22) PCT Filed: Dec. 5, 2008
(86) PCT No.: PCT/US08/85678

§ 371 Date: Feb. 7, 2011

Related U.S. Application Data
(60) Provisional application No. 60/992,513, filed on Dec. 5, 2007.
(60) Provisional application No. 61/079,969, filed on Jul. 11, 2008.

(51) Int. Cl. H04N 7/14; G06F 3/048; G10L 21/00

(52) U.S. Cl. 348/14.03; 715/757; 704/275; 704/E21.001; 348/E07.079

(57) ABSTRACT

A system and method for facilitating collaboration of a group. The system and method provide a ubiquitous anytime/everywhere environment realized through fixed and mobile technologies and scaffolded by group support software. The system includes a collaboration engine having an architecture that supports both generic collaborative processes along with task specific team processes instantiated through a sophisticated suite of advanced modular technologies. The collaboration engine drives dynamic and real time collaborative problem solving and decision making by integrating sensor and human data from the field with group support software that efficiently and effectively manages team interaction.

This is a national stage application of PCT/US08/85678, filed Dec. 5, 2008, which this application claims priority from and any other benefit of U.S. provisional patent application Ser. Nos. 60/992,513 filed Dec. 5, 2007 and 61/079,969 filed Jul. 11, 2008, the entire disclosures of which are hereby incorporated by reference.

### TECHNICAL FIELD

Certain examples of the present invention relate to facilitating collaboration. More particularly, certain examples of the present invention relate to a system, apparatus, and methods for integrating the real world with the virtual world to facilitate collaboration among members of a group.

### BACKGROUND

While there is a plethora of groupware products on the market, coordinating teamwork in an efficient and effective manner continues to be a major challenge for both public and private organizations, particularly as globalization increasingly distributes workers across multiple locales. Fortunately, technology-based research and development has given a glimpse into its ability to facilitate collaboration. For instance, groupware (i.e., electronic bulletin boards, chat systems, document-sharing, virtual multiplayer gaming and video- and teleconferencing, among other technologies) are being used to support teamwork in an attempt to communicate and coordinate activities among collaborators. However, a unified team-performance improvement systems (TIPS) or ubiquitous collaboration technology industry still remains to emerge.

The challenge is to develop a robust and open technology based infrastructure that facilitates the creation of high performance teams of people that deploy their talents, knowledge, organizational skills and systems thinking to achieve results. Problems in effective collaboration, communication and coordination can create financial losses, and depending on the situation or environment, can even result in loss of human life. Such problems can occur in many types of environments, including design problems in areas such as construction, supply-chain management, software development and implementation, or many other situations where complex efforts are made by multiple parties or teams. Regarding losses of life, many emergency response teams typically operate in the context of dynamic, time sensitive tasks where the ability to rapidly exchange information and respond, in real-time, can ultimately drive life or death outcomes. Success requires effective and rapid transfer of information, both within a team and also across boundaries of other teams with whom teams may or may not have any prior experience in working together, particularly in multi-team systems (MTS) which are networks of highly independent teams working simultaneously toward both team and higher level goals or objectives. These challenges are true regardless of the team or industry: from surgical teams and emergency response teams such as firefighting, ambulatory, trauma or recovery teams, to sports, civil infrastructure, project-management and product design teams as well as global supply chain operations (including wholesale distribution), just to name a few.

The workplace of the future is rapidly evolving into distributed workgroups that overcome the barriers created by geographical distance and time. Unlike current communication devices and systems, such as Apple's i-Phone and HP Halo, there is still a need for technologies and methods that connect the virtual and physical world using visual simulation and distributed sensor technologies.

No current single technology is known to deliver the desired collaboration system. The following representative examples of existing products are filling niche needs. HP (in partnership with DreamWorks Animations SKG) developed HP Halo Collaboration Studio. Note that this system simulates face-to-face business meetings across long distances. More importantly, this appears to be the only solution on the market that allows this kind of effective communication. However, it doesn't bring the knowledge/context in an integrated way.

IBM Lotus Notes deploys role-based work environments and speed time-to-value with dashboards, scorecards and so on. It allows tracking, routing, document management, etc., but does address the full range of integrated functionality desired.

Toyota has developed a proprietary intranet to system to promote information sharing within the company in order to raise productivity. But it does not appear that they have marketed their system as of yet. Of course, Wal-Mart and other large companies have similar systems for supply chain collaboration. However, small businesses don't have the resources to develop proprietary collaborative systems and tend to rely on rudimentary groupware tools.

Further limitations and disadvantages of conventional, traditional, and proposed approaches will become apparent to one of skill in the art, through comparison of such systems and methods with the present invention as set forth in the remainder of the present application with reference to the drawings.

### BRIEF SUMMARY

The introduction of the virtual world into collaboration tools provides a mechanism to add content, expertise, and virtual or replacement team members to support the solving of complex problems. Ubiquitous collaboration, as described herein, provides an integrated suite of collaboration capabilities and includes the capability for real-time and ubiquitous collaboration using context-driven data and team development needs. The systems and methods of the invention allow for effective coordination in organizational forms by digitizing and rapidly transmitting information, such information being characterized in a variety of forms, such as related to the status of a/each team, transferring newly acquired data/information to a team or teams, enabling teams to perform distinct aspects of tasks while properly supporting the efforts of other team members or other teams, as merely examples. The systems and methods may be widely applied to various applications and environments, including but not limited to business, healthcare, supply-chain, military, sporting, home, transportation or many other environments.

Examples of the collaborator technologies and methods described herein connect the physical and virtual worlds by gathering real-time data and collecting the wisdom of team members, even if the team members are separated by time and space. The system platform and associated devices connect co-located teams of people with individuals dispersed throughout various geographic locations. Succinctly, examples of the collaborator technologies and methods described herein transform the traditional workplace into an efficient and effective team space. The system platform addresses geographical and temporal fragmentation as well as data collection, data distribution and data visualization via remote networked sensors, visual simulations, voice recognition, among many other functions. For example, all the team members may be seen as they chat synchronously (same time) or query each other asynchronously (different time), working together in the solution of a complex problem and arriving at a collective decision. Examples include an open collaboration platform as well as a family of ubiquitous collaborating devices, systems, and services.

Examples of the ubiquitous collaborator system are designed such that they are usable in a variety of industries, environments, applications and the like, thus having significant and broad impact. The societal impact rests on the fact that problems in coordination and communication continually create not only financial losses, but losses in lives. For example, the ubiquitous collaborator system may be used not only to help redress design problems before they occur in areas such as construction, supply-chain management, or software development, but also in enabling synchronization of complex efforts involving multiple teams. The systems and methods allow for operation in the context of dynamic, time sensitive tasks with their ability to rapidly exchange information in real-time. The systems and methods allow for rapid transfer of information both within the team, and also across the boundaries of other teams with whom teams may or may not have any prior experience working, including multi-team systems (MTS) or networks of highly interdependent teams working simultaneously toward both team and higher level goals. Such teams may require the coordinated effort between teams, such as in emergency response conditions, such as teams of specialized EMT, firefighting, ambulatory, trauma, and recovery teams.

Ubiquitous collaborator based technology may significantly impact coordination within these and related organizational forms by digitizing and rapidly transmitting information regarding the status of each team, transferring newly acquired information to other units, and enabling teams to perform distinct aspects of their tasks while properly supporting the efforts of other team members or other teams in the system.

Examples herein support the development of an entire industry based upon the concept of ubiquitous collaboration. Although current industries separately serve collaboration, they have yet to do so from a scientific and technical base arising from team theory. As such, the potential for both a powerful impact on productivity, and on an emergent industry is great.

Creating and implementing a ubiquitous collaboration system provides a unique opportunity through which to support a tremendous variety of complex collaborative tasks, impacting a number of industries and leading to significant economic development and increased productivity.

These and other advantages and novel features of the present invention, as well as details of illustrated examples thereof, will be more fully understood from the following description and drawings.

### BRIEF DESCRIPTION OF THE DRAWINGS

FIG. 1 illustrates an exemplary example of a table top ubiquitous collaborator unit placed on a conference room table;

FIG. 2 illustrates several exemplary alternative examples of a table top ubiquitous collaborator unit;

FIG. 3 illustrates an example of a ubiquitous controller system architecture to provide the various functions of data acquisition, data distribution, and data visualization to support virtual elements;

FIG. 4 illustrates various exemplary examples of smaller portable ubiquitous collaborator devices that look similar to laptops or interconnected (foldable) PDAs with a built in telescopic camera;

FIG. 5 is a table illustrating the technologies, processes, and content that are all taken into account as part of the ubiquitous collaborator integration;

FIG. 6 illustrates an example representing a global view of the ubiquitous collaborator networked sensor architecture;

FIG. 7 illustrates an important theoretical breakdown and includes examples of how a collaboration system may be conceptualized to support foundational team processes; and

FIG. 8 illustrates an exemplary example of software architecture of a speech recognition system according to an example.

### DETAILED DESCRIPTION

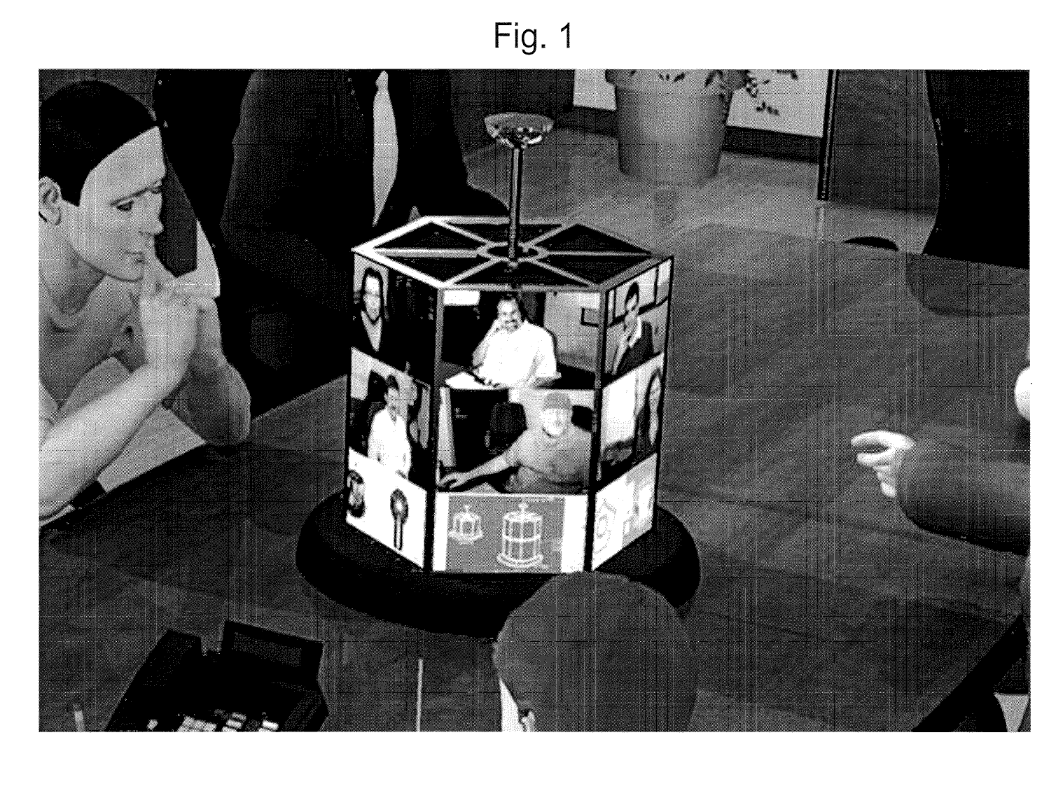

As an integrated hardware-software-network open platform, examples of ubiquitous collaborator devices and systems, as described herein, may be designed in different sizes and configurations. For example, referring to FIG. 1, a basic conference room (table top) unit may comprise a flattened cylindrical shape where the sides are standard LCD panels or foldable (collapsible) LCD segments (e.g., similar to i-Phones connected in parallel side-by-side). Such an example provides an upper level ring of display and user interface panels, a middle level ring of display and user interface panels, and a lower level ring of display and user interface panels. For example, the upper level ring may be used for displaying team members co-located at a first site and the middle level ring may be used for displaying team members co-located at a second site. The lower level ring may be used to display virtual documents and/or models, for example, which may be manipulated by the team members at the various sites. The system may further comprise one or more microphones or other speech detecting system or the like to detect speech or other sound or audio sources.

The ubiquitous collaborator processor (engine) may be located in the middle of the unit and a protruding telescopic post holding a 360 degree camera (e.g., of the type provided by Immersive Media) is provided, projecting the image of team members (real-time image). The unit may rotate on a Lazy Susan type platform. Sizes and shapes may vary from model to model. A power plug and Ethernet connection may reside beneath the unit. The unit may be voice-activated, allowing hands free operation, for example. Alternatively, a half unit having a 180 degree view may be configured and placed up against a wall, for example. The unit may be configured to grow as a user's needs grow. The processor engine has various software systems for performing various processing functions as desired for various uses, such as for examples described subsequently as well as various other functions as may be contemplated for general or dedicated systems for various applications.

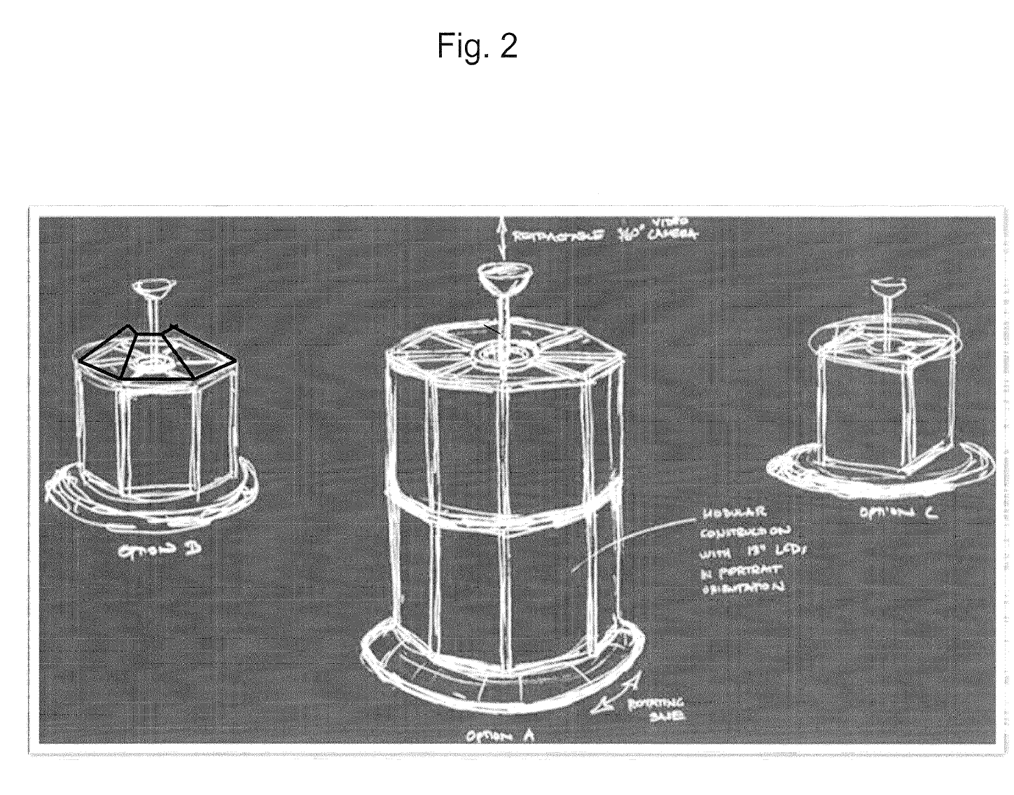

FIG. 2 illustrates several alternative options of the desk top unit. Option A provides an upper level ring of display and user interface panels and a lower level ring of display and user interface panels. Option B provides a rotating cylinder configuration with slightly slanted surfaces for displaying participants. The lower ring of display surfaces are used for displaying virtual document, models, etc., with which the participants may virtually interact. Option C provides a simpler cuboid type of configuration.

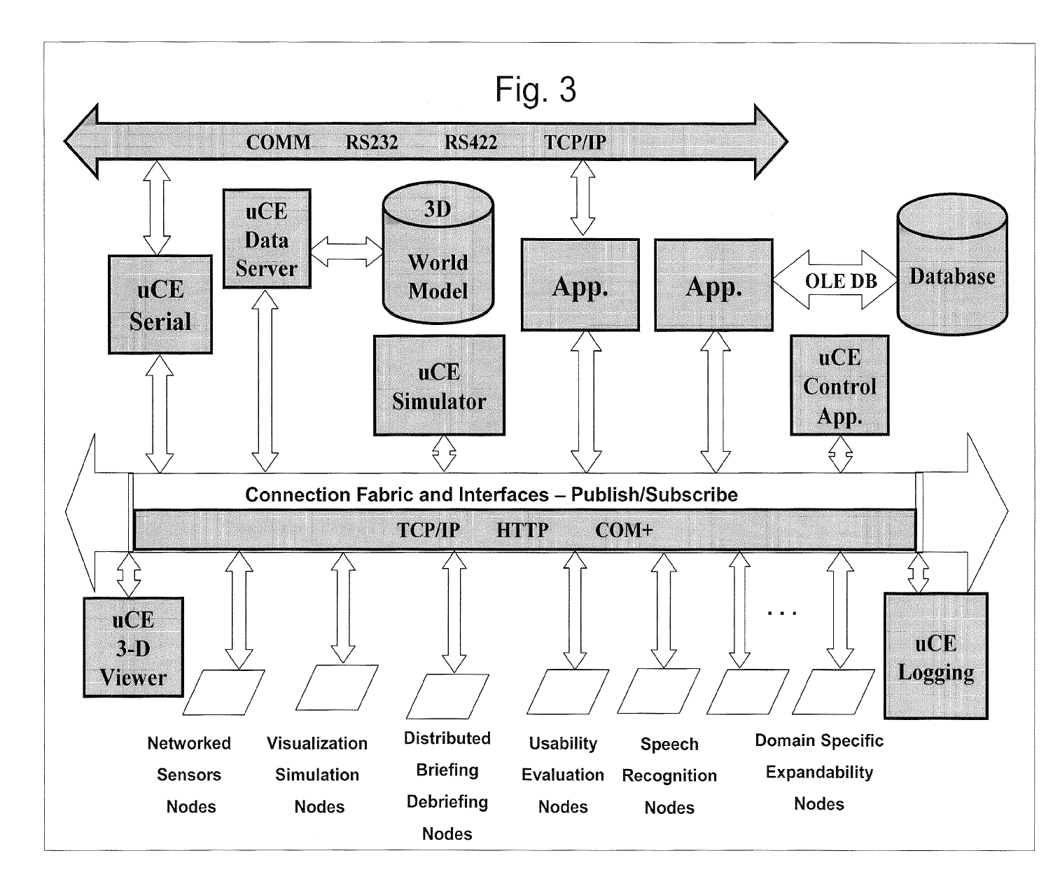

FIG. 3 illustrates an example of a ubiquitous controller system architecture to provide the various functions of data acquisition, data distribution, and data visualization to support the virtual elements that may be displayed on the lower ring of the display surfaces, for example. Such an architecture includes e-sensors, databases, 3D viewers and manipulators, as well as various communication features and protocols. Other system components can include security and/or monitoring systems, such as a microphone array and/or movement detection systems for example, to automatically alert to the presence of individuals in the vicinity, or to focus data acquisition systems on particular individuals for example. Systems may also include automatic translation of speech into desired forms, such as other automated speech and/or into text form as may be desired. For non-audible signals, or non-speech applications, signals may be detected by suitable sensing systems, such as vibration or seismic sensing for example, visible or non-visible electromagnetic signal sensing, or any other suitable detection system for other types of information.

As examples, such systems could be used in implementation of smart conference rooms, smart court rooms or the like. In such environments, multiple people are typically interacting and it would be desirable to capture data and information automatically, and transfer or communicate data and information, in real time if desired, for collaboration. In such applications, the attending members in the conference room(s) may be allowed to initially enroll, and their speech image to be identified, thereby allowing for automatic transcription of the meeting discussion, with speakers automatically identified. Such an approach could also be applied to telephonic or like conferencing, with the ability to retrieve information on the fly, and dynamically manage the participants in the conference, which may simply be done using voice commands or the like, and without knowledge of a particular phone system. Similarly, in the context of a court room, automatic transcription could be performed to replace human transcription normally performed, with documents reflecting proceedings generated automatically and shared with appropriate entities.

In other environments, such as automobiles or other transportation modalities, voice controlled management of vehicle systems, navigation or other functions could be implemented, either independently or in coordination with other systems, based on voice commands in a completely hands free mode. Information regarding the vehicle systems, or communication with other parties may also be provided via wireless communication to interact and collaborate with others. In association with air transportation or the like, the pilot or other operators typically need to spend significant time in manually programming flight or other route plans and information, and the systems and methods of the invention would allow such activities to be performed via speech recognition or in other more automated manners to increase accuracy and efficiency. In the home or like environments, with wireless communication systems and the use of microphone, camera or other sensor or monitoring systems, it is possible to interface a computer system or communication system to monitor locations, to interface with appliances and electronic devices, and to provide information relating thereto to a collaboration system. Adding a speech interface to the system would allow one to control the appliances, electronic devices or the like using voice commands, and may be operated on a continuous listening mode. Smart rooms, homes, offices, etc may be realized via interfaces according to the invention, allowing command and control speech recognition functions, automatic monitoring or transcription or data capture or other functions as may be desired for various applications. In other applications, such as for use by disabled individuals, the collaboration systems or components and methods of the invention may facilitate the ability to operate and manage appliances, devices and the general ability to live more independently and easily. Many other applications can be envisioned and are contemplated within the invention, to enhance the ability to input data or information to a system, to control systems within an environment, where visual cues are important or the like.

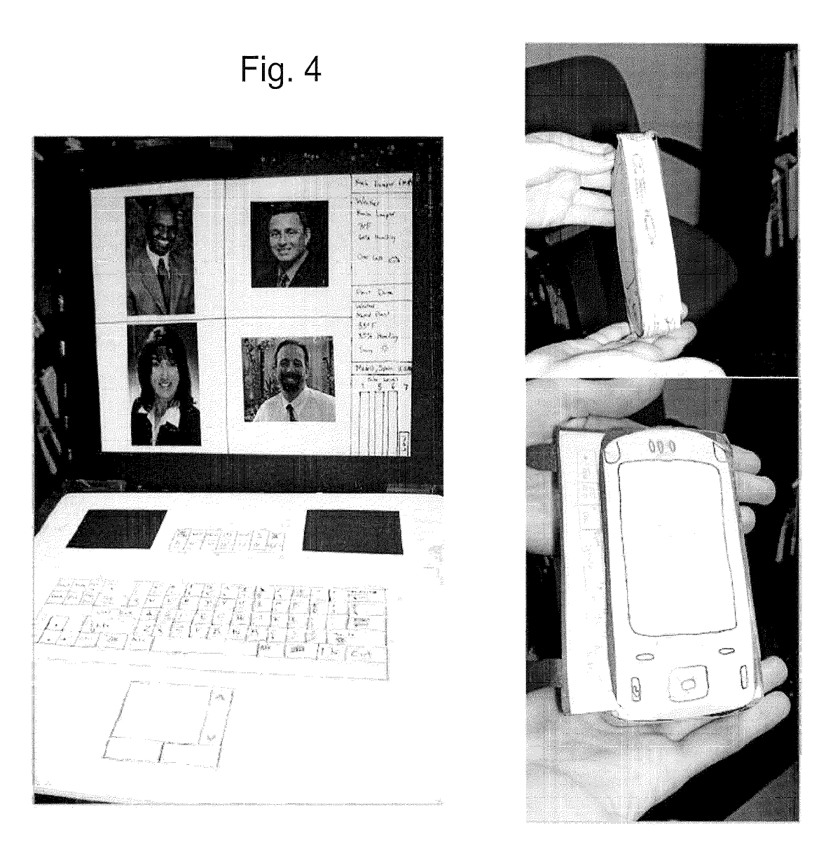

For users in a different time zone, the system provides asynchronous mode capabilities by storing pre-recorded video or simulations. Users may be able to select the way that video images and workspace visualization data are displayed on the LCD screens. For example, teams at various sites may be selected to appear on rings (bands) of the display (so that anyone sitting on opposite sides of the table are able to see the participants at various locations). Such a tabletop unit may be located in the center of the conference table (at each locale) with business executives, researchers or others, around the table or against a wall. The tabletop system has a handle for easy transportation, while the smaller portable devices look similar to laptops or interconnected (foldable) PDAs with a built in telescopic camera (see, for example, FIG. 4).

The ubiquitous collaborator system provides a ubiquitous (anytime, everywhere) environment realized through mobile and fixed technologies and scaffolded by group support software. At the core of this integrated platform is a collaboration engine (processor) consisting of an architecture that supports both generic collaborative processes along with task specific team processes instantiated through a sophisticated suite of advanced modular technologies. The collaboration engine drives dynamic and real-time collaborative problem-solving and decision-making by integrating sensor and human data from the field with group support software (groupware) that efficiently and effectively manages team interaction. The system may be designed using rapid-prototyping and concurrent design methodologies (i.e., designing the product and the system processes to build the product simultaneously). The systems and methods may provide assimilation of the virtual world into collaboration tools to provide a mechanism to add content, expertise, and virtual or replacement team members to support the solution of various problems and/or enhance activities of individuals or team members. The systems and methods may provide an integrated suite of capabilities and/or real-time capabilities, and may utilize context-driven data (visual, audio, verbal, numerical, etc.) and team development needs. The systems and methods may connect the virtual and physical worlds/environments by gathering data, which may be in real-time, and integrating information and expertise from team members, even if the team members are separated by time and space. The system and methods and associated components or devices/sub-systems can be used to connect co-located teams of people with other teams or individuals dispersed in different geographical locations, as well as temporal fragmentation. The systems and methods may provide data collection, data distribution, data visualization, data manipulation and other functions, via remote networked sensors, embedded sensors, visual simulations, voice/sound recognition, and many other functions. The systems and methods may allow interaction between team members synchronously (same time) or asynchronously (different times). Tools may be provided for effective problem solving/decision making, such as software tools, data processing tools or the like, and sensors, being embedded or discrete, can provide meaningful content regarding the environment or context in which the team or members are operating and interacting (such as in 3D or 2D interactions). Sensors can augment the reality of the environment, such as merely examples, providing patient data or statistics, environmental conditions (e.g. storm surge/height/location data, wind speed, etc.), and can be used to generate or enhance simulation data.

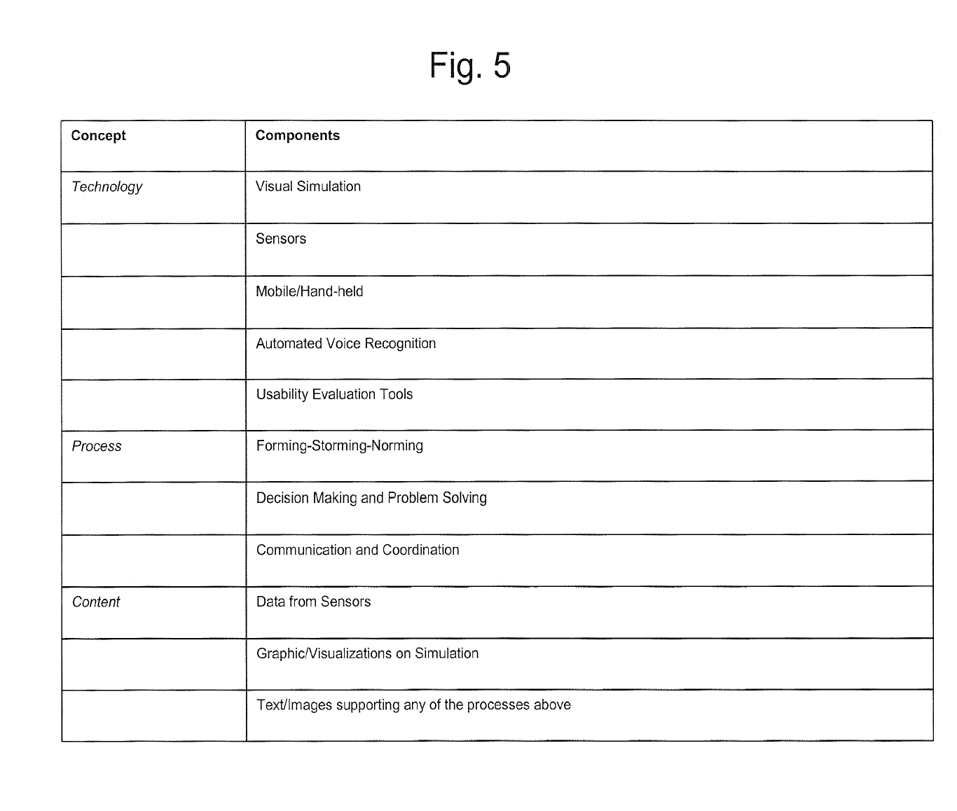

Examples of the ubiquitous collaborator systems and methods described herein are just several of the myriad of possible examples of systems and methods according to the invention, and should not be held to be limiting thereof. The systems and methods may be developed using a systematic program of research and development in order to seamlessly integrate extant theory on team process and performance with developing technologies. Technologies, processes, and content are all taken into account, with examples shown in the table of FIG. 5. While some of these technologies exist, they are either underutilized or used in a piece-meal fashion. Yet-to-be-developed technologies may be integrated as developed in a seamless manner. Certain examples herein fully integrate such existing or to be created technologies with distributed collaboration technologies.

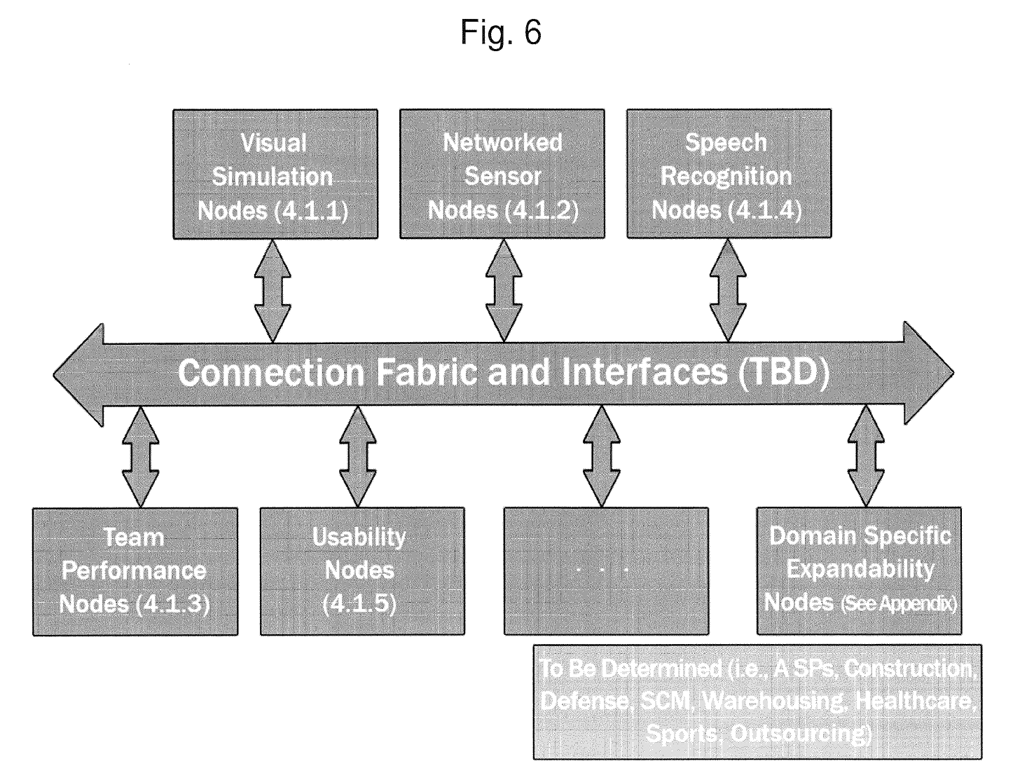

FIG. 6 illustrates an example representing a global view of the ubiquitous collaborator networked sensor architecture. The ubiquitous collaborator characteristics and capabilities may include integration of web-based visual simulation with correlated interoperation and expansion of features on a variety of platforms, including mobile computing and telephony devices. Further, certain examples include powerful data acquisition and database connectivity features that are integrated into the ubiquitous collaborator platform. Furthermore, Distributed Supply Network capabilities provide supply-chain management (SCM) collaboration tools and associated networked sensors to improve team decision-making performance and help characterize and reduce the risks, uncertainty and variability associated with the local, regional and global supply-chain of products and services. Also, Distributed Briefing-Debriefing (DBD) provides portable tools to support distributed team processes and support performance improvement. Specifically, such features are provided in a web-based 3-D game environment that allows team members to collaborate on some set of tasks in predefined scenarios. Furthermore, Automated Voice Recognition and Usability Evaluation tools help to ensure that readability, comprehension and clarity of information is exchanged to enhance virtual team performance. The characteristics and capabilities may include other systems to facilitate providing desired information to the ubiquitous collaborator beyond that shown in FIG. 6.

Certain examples include a family of new ubiquitous collaborator devices and integrated systems for: (I.) sensing, collaborating, analyzing and responding to rapid changing requirements and demands and (II.) making real-time decisions under risk and uncertainty. The ubiquitous collaborator tools are based on visualizing quantitative and qualitative data (via integrated dashboards), information and tacit knowledge; radio frequency identification techniques; sensors and network communications, and adaptive (sense-and-response) systems, among other technologies now in place or to be created.

An example may include a client server architecture platform optimized for visualization to accommodate multiple users employing heterogeneous hardware and software platforms. Such optimizing includes accommodating multiple viewpoints from different users supported by multiple rendering pipelines in the server to support different user points of view. Furthermore, such optimizing includes accommodating different graphics capabilities among ubiquitous collaborator machines, and the implications thereof. To avoid overloading the server, there is some benefit by utilizing the graphics capabilities that are inherent in a particular ubiquitous collaborator device. Additionally, runtime formats for graphics systems may be very different resulting in correlation differences between devices which are accommodated.

Certain examples include the use of pointers and context information. Ubiquitous collaborator users may wish to highlight a particular feature on a scene for others to see. Because scene content may vary and be rendered differently, it is possible to highlight the particular feature such as by affixing the pointer to the intended feature, such that the feature is highlighted regardless of the scene content variations or different methods of rendering.

A fast algorithm is provided to send information to a ubiquitous collaborator device. Bandwidth and latency are addressed with respect to digital transmission means and associated topology. (e.g., star network with wireless USB or Firewire between a star node and the ubiquitous collaborator device). Ubiquitous computing involves technical and security trade offs between location of information. The ubiquitous collaborator system provides the appropriate infrastructure for passing information (e.g., the emerging G3 telecom standard as a launch infrastructure with digital links to individual computing devices). Furthermore, certain features of the ubiquitous collaborator system include acquisition of relevant context information, information pruning for devices with lesser capability than other devices, voice recognition in noisy environments (e.g., using a repertoire of guided prompts to users), generation of timely and relevant content creation, and adjustment or adaptability of the design for widely varying constituencies.

Examples of ubiquitous collaboration processes and methods account for virtual teaming arrangements (flow of operations/work in virtual team collaborations), technologies used within each process, and potential human errors and bottlenecks within each process. Bottlenecks may be defined as any element within a process that decreases efficiency and safety within an organization.

Examples of the ubiquitous collaborator system integrate visual simulation functionality. Capabilities apply to both regular and limited visibility situations, such as mining, nuclear power plants, and underwater recovery operations, among a wide variety of other applications.

As an example, in harsh underwater environments, drastic loss of visibility associated with depth, combined with enormous pressures and low temperatures makes it a place where only tele-operated construction equipment and robots may operate. Limited feedback from robots and cranes makes underwater construction a very expensive and time-consuming process. Many conventional technologies such as GPS, laser tracking, and radio waves have limited range or simply don't work because of physical reasons. As a result, the sensors currently used provide limited information. The cameras available today can only provide an image of the immediate vicinity even under good visibility conditions. To complicate things even further, the data collected by all these sensors and cameras is often scattered across many systems, making its perception and analysis very difficult. All these factors adversely impact decision making. These or other limitations of the environment, systems or other aspects of a particular situation, such as the poor perception conditions in this example, may be improved through visualization, visual data consolidation, and management techniques using the ubiquitous collaborator set of tools.

The ubiquitous collaborator visual simulation capability improves the perception and understanding of scenes where near real-time data is available. Algorithms, heuristics, software development, and lessons learned from research may be applied. An example of the ubiquitous collaborator architecture (refer to FIG. 3) includes three families of network-enabled applications and services: data distribution, data acquisition, and data visualization. The core of the data distribution suite includes a real-time database server and a publish-and-subscribe service library for example. In this example, the real-time database server may be responsible for maintaining an accurate representation or world model of all the elements that compose the underwater scene. The publish-and-subscribe library allows all other applications to synchronously and concurrently receive update notifications and query information about the world model. The data acquisition suite includes applications customized to gather data from specific sources and publish the information to the real-time database server. This suite of applications may also include database access stubs and general-purpose simulators. Together, the data acquisition applications are responsible for updating the world model so that it accurately represents the underwater scene.

The data visualization suite may include applications that subscribe to the real-time database server, receive updates every time the state of the world model changes, and present the most current state of the scene to the user using 2D or 3D perspectives. In this manner, different viewers at different locations in the network may display the state of the underwater scene in a synchronous fashion. Content may be added to acquired data to complete the 3D representation.

Certain tools exist such as, for example, Presagis Creator. However, these tools require manual intervention to add content. Examples of the ubiquitous collaborator methodology automate the process through AI methods that may consider features or characteristics such as texture patterns, similar objects, or user identified characteristics/preferences. The ubiquitous collaborator system, while providing useful insights, may also seek confirmation from the user. Image processing techniques are used to build complete images from several incomplete, but overlapping views. Finally, computer generated or external images are added where none exist in the real world image. Adjustments are provided to align dynamic brightness ranges of the real and computer generated images, accommodate occlusion through approaches such as known distance markers in a scene, range finders, ray tracing, and enhancing feathering approaches for near real time implementation.

An example of the real-time database server of the ubiquitous collaborator system maintains and distributes an accurate representation of the underwater scene in this example. The server represents the scene using an efficient data structure termed the world model, which includes a list of entities with properties designed to represent their real-world counterparts in an underwater scenario. This model is expandable and flexible enough to adapt to the unpredictable nature of subsea tasks. A scene may be made of five types of entities:

Surfaces: Due to the amount of points that surveying instruments may produce, a multi-resolution surface model may be used that is capable of representing surfaces with hundreds of millions of polygons, yet is fast enough to render them at acceptable frame rates. Other techniques, such as the use of spline methodologies may also be used for example. The multi-resolution surface model may be updated in near-real time making it useful for surveying applications and navigation as well as underwater construction.

Objects: Static and dynamic objects may be represented using CAD geometry or basic shapes (e.g., cubes, cylinders, spheres, cones, etc.). Complex objects with high polygon counts may be handled through the use of interactive level of detail (LOD) management. Dynamic objects are updated through the use of bindings that link objects in the virtual environment with their counterparts in the world model. These objects may have multiple cameras, multiple lights, multiple sensors, and/or multiple indicators.

Cameras: This entity does not have a real-world counterpart, but it is used to represent the concept of a camera in the virtual environment. They may be attached to moving objects and may be configured to track entities as well. Cameras align, though, with the real world so that imagery may be properly merged. Computationally efficient algorithms have been created for coordinate conversions that maintain a proper level of precision and accuracy to minimize anomalies in the composite image.

Indicators: These entities are used to represent the value of a field or property according to some predefined behavior and/or appearance. These entities may also represent a conceptual property that exists in the real world; for example, the distance between two objects or a projection distance between an object and a surface.

Lights: These entities may not have a real-world counterpart in many scenarios, but they are used to represent the concept of a light source in the virtual environment.

The main objective of the data acquisition applications is to update the state of the world model by acquiring and publishing the data originating from disparate data sources. As an example, there may be three different groups of data acquisition applications:

Sensor gathering: These applications interface directly with the sensors that provide the data. Common examples range from simple embedded microcontrollers with Analog-to-Digital (A/D) converters to sophisticated survey computers communicating through serial cables.

Data processing: These applications commonly generate and publish new information by subscribing to the data gathered and published by other applications. Common examples are data filters and general-purpose simulators.

Database stubs: These applications serve as gateways to high-end databases and they are responsible for publishing information that is relevant in the world model.

Data visualization tools are a collection of specialized component-based modules designed to shorten the development cycle of complex virtual environment applications, providing a plurality of levels of abstraction, such as three different levels of abstraction.

Although the description above is oriented to the harsh underwater environment, it is also applicable to other situations, environments or applications where incomplete or dynamic topological information may be available with respect to the environment. Other harsh environments may be underground environments or outer space environments for example. Many other environments are also contemplated. For example, the proposed system may be used in large warehousing, healthcare, and construction operations to make routing or other decisions in 3-D. In addition, this visually-based decision-making system may be applied to other fields such as aviation, military, ship-building and tracking, service, manufacturing, construction and underwater searches, and many others. An example of the system is web-enabled for dispersed team collaboration.

To enhance ubiquitous collaborator effectiveness, the systems and methods of the invention may provide the ability to push and pull information from various e-sensors. There are two types of sensors that may be identified based on their function and connectivity to a handheld example of the ubiquitous collaborator concept: (a) sensors that are directly connected to the handheld example; such as cameras or an array of microphones as well as sensors specialized for specific use of the device (e.g., cardiac pulse monitoring sensor); (b) sensors connected to the network accessible by the ubiquitous collaborator device; such as, Accelerometers, Pressure Sensors, Gyroscopes, Piezoelectric Sensors, Geophones, Microphones, Cameras and/or many other types of known or to be created sensor technologies.

The function of the sensors connected to the ubiquitous collaborator system groups them as a sensor that serves the purpose of: (a) controlling the device itself, (b) sharing its data with other users connected to the network, or other desired purposes. Note that a sensor may have dual use like, for example, an array of microphones which may be used to control the device as well as share the data with the users (i.e., voice is being transmitted over the network).

Integration of a large variety of sensors producing distinctive data measurements may be achieved within existing global communication system technologies. Namely XML in conjunction with XSL is specifically designed to bridge the gap of heterogonous data representation. XML is a general-purpose markup language. It may be used to facilitate the sharing of structured data across different information systems (i.e., Internet). It allows definition of custom tags. XSL is a language for expressing style sheets. An XSL style sheet is a file that describes how to display an XML document of a given type. To achieve, this XSL contains: XSLT: A transformation language for XML documents. It is used as a general purpose XML processing language. XSLT is thus widely used for purposes other than XSL, like generating HTML web pages from XML data. In examples of the ubiquitous collaborator system, this will allow standardization of the displaying software, namely, use of browsers; XPath: A language used for navigating in XML documents; XSL-FO: Advanced styling/formatting features, expressed by an XML document type which defines a set of elements called Formatting Objects, and attributes. Other known or to be created technologies are contemplated.

Examples of the ubiquitous collaborator system include Distributed Briefing-Debriefing (DBD) capabilities that provide portable tools to support team processes and performance improvement. Both the military and the sport sciences have long relied upon preparing for and analyzing performance (i.e., the military has developed “after-action review” technologies to diagnose performance errors and sports teams rely upon “game-tapes” to both prepare for upcoming competitions as well as to detect errors in coordination from prior games.) Techniques such as these are just as important in the context of any number of complex coordinative operations experienced in industry, research or other environments today. As such, the development of portable systems in support of DBD may result in significant gains in collaboration effectiveness across industries as diverse as surgery, software design, construction, and a wide variety of other applications.

The translation of best practices from the training sciences to team-based organizations has been slow despite a substantial body of data showing how process and performance may be improved. The challenge is to create an environment where researchers across disparate disciplines, such as the engineering and information sciences, are able to collaborate with those in the organizational sciences to produce team performance technologies. These technologies not only capture relevant contextual information that is often outside the electronically mediated data stream but they also scaffold distributed problem solving and decision making best practices identified from the team performance literature while also instantiating visualizations of both data from sensors and from team members who are not co-located.

The theoretical backdrop, against which the ubiquitous collaborator system has been developed, is the notion of team competencies (i.e., factors that foster effective interaction behaviors and performance). Some competencies are required in every team situation, that is, regardless of mission or organization, team-generic competencies such as communication are a necessary component of effective interaction. Other competencies may be team-specific, that is, competencies meaningful only in specific team situations (e.g., idiosyncratic role knowledge of other team members' abilities). This framework further suggests that some competencies are influenced by task characteristics and may be either task-generic, that is, required across all tasks, or, task-specific.

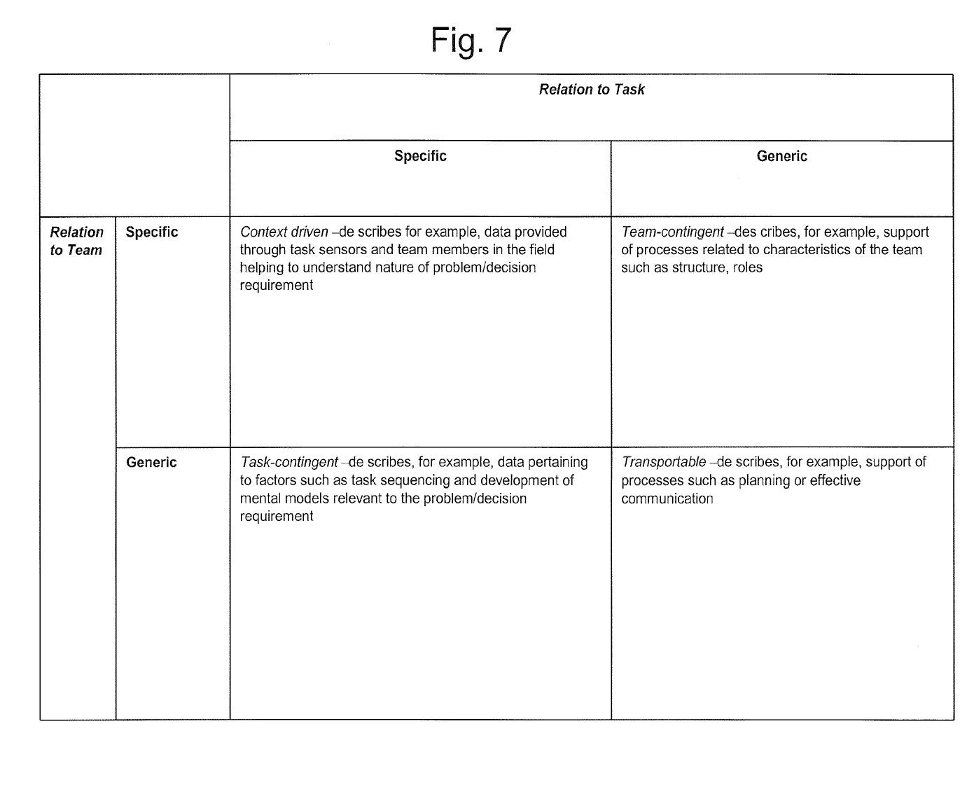

The ubiquitous collaborator technologies are based upon the aforementioned framework. FIG. 7 illustrates this theoretical breakdown, but also includes examples of how the collaboration system may be conceptualized to support foundational team processes. Specifically, systems are created that are able to utilize real-time data from team members who are not co-located and from sensors in the field to support distributed interaction as collaboration unfolds dynamically. First, through the development of simulation-based visualization and group support software, the ubiquitous collaborator technologies provide a powerful range of collaboration tools usable in more conventional business locations. Second, through the use of hand-held and mobile devices, the ubiquitous technologies support collaboration with distributed members who may not have access to high-end simulations.

Representative generic team and task factors that may be supported include conflict resolution, collaborative problem solving, communication, performance management, and planning and task coordination. For example, a mobile component of the system may scaffold planning processes via support of information management to align team interdependencies (e.g., real-time data targeting team leaders). A fixed component of the system may use simulations to scaffold collaborative problem solving, that is, simulations to help team members identify critical problem cues and effectively represent such data in service of eliciting appropriate team member participation.

Examples as described herein may include a friendly and intuitive ubiquitous collaborator interface via Automatic Speech Recognition (ASR). ASR enables a computer to convert a speech audio signal into its textual transcription. While many tasks are better solved with visual, pointing interfaces or keyboard, speech has the potential to be a useful interface for a number of tasks where full natural language communication is useful and the recognition performance of the Speech Recognition (SR) system is sufficient to perform the tasks accurately. This includes hands-busy or eyes-busy applications, such as where the user has objects to manipulate or equipment/devices to control, as envisioned usages of the ubiquitous collaborator technologies.

Some motivations for building ASR systems are, to improve human-computer interaction through spoken language interfaces, to solve difficult problems such as speech to speech translation, and to build intelligent systems that may process spoken language as proficiently as humans. Speech as a computer interface may have numerous benefits over traditional interfaces such as a GUI with mouse and keyboard. Speech is natural and intuitive for humans, requires no special training, improves multitasking by leaving the hands and eyes free, and is often faster and more efficient to transmit than using conventional input methods.

In-spite of significant advancement of SR technologies, the true natural language interaction with the machine has not yet been achieved with state-of-the-art systems. Today's speech enabled human-machine interfaces are still regarded with skepticism, and people are hesitant to entrust any significant or accuracy-critical tasks to a speech recognizer. Despite the fact that SR is becoming almost ubiquitous in the modern world, widely deployed in mobile phones, automobiles, desktop, laptop, and palm computers, many handheld devices, telephone systems, etc., the majority of the public pays little attention to speech recognition because they aren't robust enough against false positives (i.e., false acceptance). For example, the driver of a speech-enabled automobile would likely be quite unhappy if his or her headlights suddenly turned off because the continuously listening speech recognizer misunderstood a phrase in the conversation between driver and passenger.

For example, a speech recognition (SR) technology named Wake-Up-Word (WUW) bridges the gap between natural-language and other voice recognition tasks. In order to understand how the system functions, it is necessary first to describe this novel paradigm afforded by WUW. WUW SR is a highly efficient and accurate recognizer specializing in the detection of a single word or phrase when spoken in the context of requesting attention, while rejecting all other words, phrases, sounds, noises and other acoustic events with virtually 100% accuracy.

From the presented definition of WUW paradigm, two problems emerge that should be simultaneously solved: (1) Correct WUW Detection and Recognition—which is called in-vocabulary (INV) task, and (2) Correct Rejection of all other non-WUW's acoustic events—which is called out-of-vocabulary (OOV) task. In practice, the WUW-SR system should achieve correct rejection rate of virtually 100% while maintaining high correct recognition rates of over 99% in order to be useful. The task of rejecting OOV segments is difficult, and there are many papers in the literature discussing this topic. Typical approaches use garbage models, filler models, and/or noise models to capture extraneous words or sounds that are out of vocabulary. For example, a large number of garbage models may be used to capture as much of the OOV space as possible. Also, OOV words may be modeled by creating a generic word model which allows for arbitrary phone sequences during recognition, such as the set of all phonetic units in the language. As an example, such an approach yields a correct acceptance rate of 99.2% and a false acceptance rate of 71% on data collected from the Jupiter weather information system (MIT). The WUW system extracts the following features from the audio stream: MFCC, LPC smoothed MFCC, and enhanced MFCC, a proprietary technology. Acoustic modeling is performed with Hidden Markov Models (HMM) with additional proprietary technology. Other techniques and technologies are contemplated.

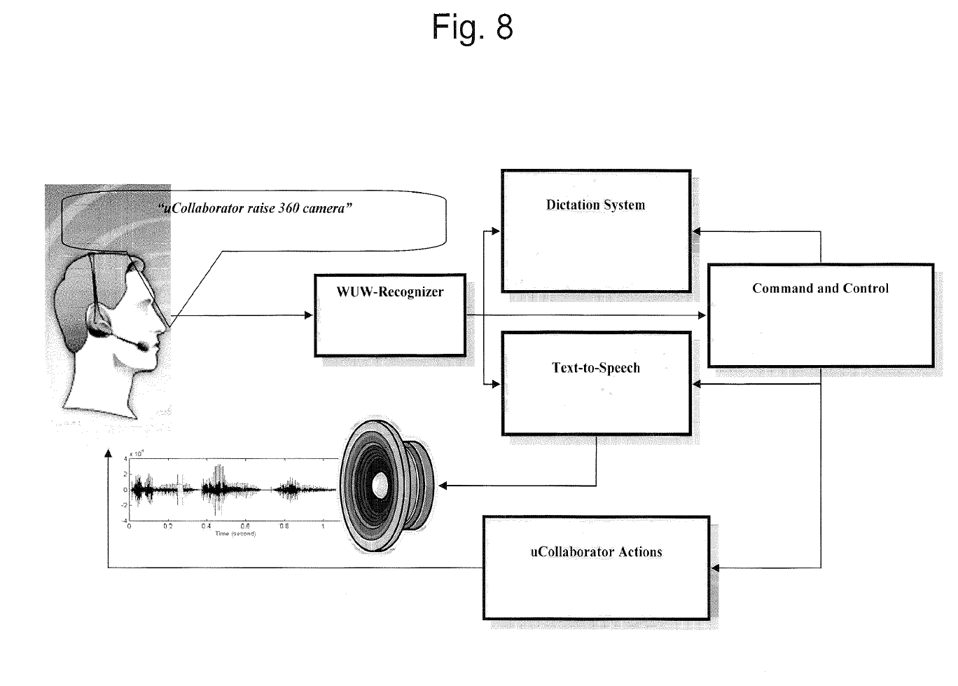

As an alternative, existing commercial speech recognition development technologies may be leveraged to perform the following tasks: (a) Command-and-control; (b) Text-to-speech; and (c) Dictation. The software architecture of such a system is depicted in FIG. 8. As an example, the WUW-SR may be licensed from Voice Key, while the Microsoft's Speech recognition Development Toolkit (SDK) may be used for free with Windows operating systems. Other commercial technologies may be licensed if the ubiquitous collaborator system is to run in platforms other than Windows (e.g., Nuance Inc.).

Examples of the ubiquitous collaborator technologies may provide Usability Evaluation tools to ensure that readability, comprehension and clarity of information is exchanged to enhance virtual team performance. This may be accomplished through various steps, such as (a) performing task analysis to gain specific insight into current virtual teaming processes (e.g., within specific domains such as supply chain management and healthcare) regarding accomplishing work goals to include analysis of present and potential bottlenecks impacting team performance. Task analysis in predetermined domains may identify the processes, technologies, documentation and bottlenecks associated with team performance in a predetermined domain. From this, processes, including main and sub-step processes, may be developed and deployed to provide effective operations and problem solving in predetermined domains. In addition, the step of (b) performing an error analysis to identify specific recommendations for features in the ubiquitous collaborator devices and systems that enhance virtual teaming through designing out the inefficiencies, problems, bottlenecks or the like identified in the task analysis, may be performed. This can include determining present and potential or perceived errors, identifying performance shaping factors affiliated with any process or sub-process, identifying the barriers and/or controls within each process or sub-process, identifying the error effects of possible outcomes affiliated with each process or sub-process, developing a risk matrix reflective of the information as developed suitable for virtual team environments, and identifying and validating recommendations for the systems and methods of the invention for collaborating in a predetermined domain. Further, the step of (c) developing an ideal flowchart to depict how the features identified in the error analysis will optimize virtual team performance can be developed and the step of (d) performing usability testing enabling user feedback to be provided throughout the design process can be performed. The task and error analysis together provide vital input to the functional requirements to ensure that the ubiquitous collaborator devices and systems capture user needs in terms of supporting and optimizing their work. The usability testing provides vital input to the usability requirements regarding certain examples of the ubiquitous collaborator devices and systems. The following further describes each of the research methodologies:

Process flowcharts may be developed through conducting a task analysis in selected domains to identify the processes, technologies, documentation, and bottlenecks affiliated with virtual teams through: (a) conducting a literature review identifying technologies and bottlenecks affiliated with virtual teams; (b) interviewing professionals part of virtual teams to identify their processes, bottlenecks affiliated with each process along with technologies and documentation utilized; (c) reviewing organizational documentation such as virtual team policies to identify explicit knowledge in existence; (d) developing flowcharts that display processes, sub-processes, bottlenecks, documentation and technologies; and (e) validating the flowcharts through gathering individuals affiliated with different processes to collectively review and update the flowcharts for accuracy or based on further experience or information.

The error analysis includes analyzing the flowcharts developed in the task analysis by developing a table through: (a) listing the main process and sub-process steps; (b) listing the present and potential errors (bottlenecks) that consist of all perceived errors within each process and sub-process; (c) identifying the performance shaping factors, reasons that impact team performance, affiliated with each process and sub-process; (d) identifying the barriers and controls within each process and sub-process of potential physical barriers impacting team performance as well as controls such as policies in place that could impact team performance either positively or negatively; (e) identifying the error effects of all possible outcomes affiliated with each process or sub-process; (0 developing a risk matrix suitable for virtual team environments by adjusting prior risk matrixes developed in prior space and research (e.g., healthcare industry research); the matrix enables each process based on the information collected in the worksheet to be assessed on detection, severity, and likelihood of the risk factor to occur; (g) identifying recommendations for features in the ubiquitous collaborator devices and systems that enhance virtual teaming that design out the bottlenecks identified in the task analysis; and (h) validating the recommendations through individuals affiliated with virtual teams and collectively review the recommendations in terms of feasibility and value.

The flowchart may include a theoretical display of how the features identified in the error analysis optimize the current state of virtual teams through using the ubiquitous collaborator methodologies, devices and systems. Such a flowchart, which may be termed an ideal flowchart, is useful for designers of the ubiquitous collaborator and includes the following: (a) analyzing the error analysis worksheet and specifically the recommendations identified; (b) integrating the recommendations into the current flowcharts developed as part of the task analysis; and (c) validating the ideal process flowcharts through gathering individuals affiliated with different virtual teams in the domains studied to collectively review the flowcharts in terms of feasibility and value.

Humans rely heavily on technology and especially the Internet to carry out both professional and personal business. The role of usability researchers and practitioners are to help humans optimize efficiency in interacting with technology. Usability testing is carried out throughout the design process affiliated with the ubiquitous collaborator suite of tools and methodologies. Testing may occur both in a testbed environment and out in the field.

The testing includes not only identification of user-friendly features to incorporate in the design of the tools and methodologies, but also how to best design these tools taking into account human limitations and capabilities to enable human performance in e-collaboration environments to be optimized. Data on the ubiquitous collaborator toolset includes a combination of methods. Components may include a user test and user satisfaction questionnaire. The user test measures human performance on specific tasks. Software logging of keystrokes together with video recordings of the user's actions are used for recording user performance for the set tasks. The use of eye tracking hardware and eye-movement data reveal how long users look at different parts of the display under different conditions. This may provide data about what aspects of the display provide useful information, which allows frequently used information to be displayed more prominently. Link analysis may be used to optimize placement of components within a display based on sequential probabilities of eye fixations on components. Comparison of different display designs are conducted to determine differences in eye movement measures due to physical characteristics of the display design. The user satisfaction questionnaire is used to find out how users actually feel about using the ubiquitous collaborator tools, through asking them to rate it along with a number of scales, after interacting with it. The combined measures are analyzed to determine if the design is efficient and effective. Interviews, which are usually structured or semi-structured, may also be conducted with users. Other tools to refine the systems and methodologies can be used.

Once this stage of usability testing is completed, a series of experiments may be conducted in which a larger number of participants are required to assure the gathering of empirical data that may be statistically analyzed. The results from the experiments have practical implications and theoretical results of broad importance to the development of certain examples of the ubiquitous collaborator system.

Finally, field studies may be conducted to find out how the ubiquitous collaborator system is adopted and used by people in their working and everyday lives. Such settings are very different from the controlled environments used during the earlier usability testing, where tasks are set and completed in an orderly way. In this case, qualitative data focusing on accounts and descriptions of people's behavior and activities with the ubiquitous collaborator system is obtained that reveal how they used the product and react to its design. Data is collected primarily by observing and interviewing people; collecting video, audio, and field notes to record what occurs in the chosen setting.

In an example, these processes may assist in the development for systems and methodologies for particular applications, such as Supply Chain Management (SCM) functions and operations. This effort characterizes and reduces the risks and uncertainties associated with the global supply-chain of products and services via electronic collaboration. The ubiquitous collaborator SCM application increases the team's ability to make collaborative decisions, in real-time.

The need for ubiquitous collaborator SCM technology is evidenced by the bullwhip effect caused by seemingly low risk decisions throughout the supply-chain and the resulting exaggerated fluctuations in demand for products and services, particularly in the constantly evolving digital economy. In periods of rising demand, down-stream participants may increase their orders. In periods of falling demand, orders may fall or stop in order to reduce inventory. The effect is that variations are amplified as one moves upstream in the supply chain, further from the customer. Collaborative decision-making may help to reduce the induced variability associated with the bullwhip effect and lead to effective supply chain planning and execution. Consequently, real-time information sharing becomes increasingly important as more decision-makers collaborate with upstream and downstream supply chain partners.

Certain examples include technologies and mechanisms for: (1) sensing, analyzing, and responding to supply-chain demands and (2) making real-time decisions under risk and uncertainty. The results may be based on both quantitative and qualitative data; radio frequency identification techniques; and adaptive (sense-and-response) systems, among others. In addition, tools for supporting data-collection, collaborative decision-making and the relationships among trading partners in the supply chain without hindering human autonomy are provided.

An example model developed may be used for integrating real-time electronic communications, information-sharing, and materials-flow updating as well as monitoring the e-supply/demand/value chain. The “e-sensors” that may be used are computer programs (software code) and associated data and information collection devices (hardware) and communication interfaces. These sensors are designed for e-collaboration, data-capturing (sensing), and information-sharing, monitoring and evaluating data (input) throughout the value chain. Ultimately, this approach results in semi-automated analysis and action (response) when a set of inputs are determined (sensed) without hindering human autonomy. That is, the sensors gather the data and monitor and evaluate the exchange in data and information between designated servers in the e-partners (suppliers and distribution channel) networks. A ubiquitous collaborator SCM application may adjust plans and re-allocate resources and distribution routes when changes within established parameters are indicated. In addition, sensors may signal human monitors (operations or supply-chain managers) when changes are outside the established parameters. The main advantage of this approach is that sensors are capable of assessing huge amounts of data and information quickly to respond to changes in the chain environment (supply and demand), without hindering human autonomy. Particularly, e-sensors may provide the real-time information needed to prevent the bullwhip effect.

An example of the communication and implementation architecture is based on CORBA (Common Object Request Broker Architecture), a standard solution available from multiple vendors and an example implementation of a Service Oriented Architecture (SOA). CORBA is an open system middleware with high scalability and may potentially serve an unlimited number of players and virtually any number of business processes and partners in the supply chain environment. As a communication infrastructure, it enables an integrated view of the production and distribution processes for an efficient demand management.

The ubiquitous collaborator platform may be applied to other specific fields such as construction, healthcare, sports, outsourcing and so on. The fast growth in service industries including health, professional and business services, management, professional and scientific will drive demand for productivity enhancing processes. Demographics and global integration will become more important as well.

As an example of a ubiquitous collaboration process using a suite of ubiquitous collaboration tools as described herein, it is the year 2012. A Project Manager for Company X, is working intensively at her ubiquitous collaborator Application Service Provider (ASP) proxy office in a location, such as Kuala Lumpur, where they will be meeting with a potential client for the engineering consulting firm for which they work.

Suddenly, the Project Manager receives a voice-mail alert on their ubiquitous collaborator device notifying that the stability sensors in Storage Silo 7 of their company's new power plant being built in a separate location, such as Madrid, Spain, have indicated a problem. The Project Manager accesses the data using the ubiquitous collaborator device, and requests an up-to-date time-series graph from the sensors at that silo. Upon inspection, they see there has been increasing pressure at the base of this silo and that it could approach critical levels within days if not addressed immediately. The ubiquitous collaborator device uses the system broadcast voice feature to send an urgent message with the graph to select members of the engineering team onsite and distributed throughout the world. The message may be annotated with a ubiquitous collaborator markup feature to highlight the critical data and schedules a meeting in 30-minutes to diagnose and assess the problem.

Finally, the Project Manager may access the company's centralized Madrid database. Real-time sensor data is fed to a display screen on the ubiquitous collaborator device indicating changes in stability across several of the silos. Additional visualization data from onsite weather sensors provide readouts of moisture, temperature and precipitation in the immediate vicinity. Construction schedules and project tasking are additionally accessed.

The ubiquitous collaborator device may further notify the Project Manager when the remote team has virtually assembled and they prepare to discuss the situation. In addition to the graphics presenting the data, onsite cameras provide visual inspections of the site and the team's ubiquitous collaborator desktop system may include video display of the dispersed team members. This virtual team includes their Madrid site's construction manager, along with their onsite safety inspector. Also included is the company's resident expert in structural engineering, currently located in another location, such as Tennessee, where they have been contracted to oversee the TVA's annual dam inspection. Lastly, the Project Manager invites the company's political consultant, located in Washington D.C., a member of the team brought on due to problems with Basque separatists operating in the city of Madrid in recent years.

In Nashville, the expert in structural engineering points to an anomalous data point in Silo 39's sensor J17, presented in tabular format to the team. The ubiquitous collaborator dynamic deictic gesture projection system indicates to the distributed teammates the table in question by highlighting that portion of the screen and overlaying the pointing icon in that section of the grid. As the expert in structural engineering sweeps their hand across one of the rows of the table while explaining the concern about this data, the deictic gesture projection system similarly provides a graphical representation of this motion.

During this discussion, the Project Manager notes that the onsite project manager looks haggard even though the ubiquitous collaborator device tells her that it is only morning in Madrid. The Project Manager can tell by his lack of focus that he is clearly distracted by something. The Project Manager then uses the ubiquitous collaborator private talk feature to ask him if there are any problems. On pressing this matter, it is found that the onsite manager has spent the morning dealing with a problem with the suppliers of their silo arches. He states that their credentials seemed questionable to him and upon confronting them, they caused a disturbance. With this added information, the Project Manager goes back to the meeting mode and informs the team. The political consultant then uses the ubiquitous collaborator system to initiate an immediate web search of private and public databases related to Basque separatists' activity in the region.

The Safety Manager, was onsite instead of in their office, and has been participating using a ubiquitous collaborator handheld foldable device. They can use the inventory search function for this project to access the main office database and determine the required arch load capacity for these silos, and to determine if these match what has been delivered. Upon noting a difference, the Safety Manager goes back to meeting mode and interrupts the structural engineering expert to explain the difference and asks if silo arches at this load capacity could cause this problem.

After some discussion, the team decides that this is a distinct possibility. The political consultant comes back and displays an article form Cinco Dias, the Madrid business paper, that states that some elements of the separatist movement have been increasing their construction-sites sabotage through indirect means. The Project Manager requests a cross-check of this supplier to determine if there is any potential linkage to separatists and orders an immediate stop and inspection of all silos. Such a scenario is only a simple example of the applications that may be implemented using the systems and methodologies of the invention, and does not limit such applications in any way.

Other examples of systems and methods according to the invention could include systems and methods to connect the virtual and physical worlds using visual simulation, distributed and/or networked sensor technologies, distributed data acquisition, voice recognition and other interfaces, to provide users with the ability to add content, expertise, virtual or replacement team members, computation, access to established information and the like to assist in collaboration between at least two people at different locations or teams at different locations and/or times. Systems may include fixed systems for use in the office, home or other location, or mobile devices, such as handheld, wearable or other devices. The systems and methods may use any suitable communication modalities and protocols for communication between collaborating devices/systems, including wireless, wired, radio frequency identification techniques, touch screen, embedded or discrete sensors, network communications, and adaptive (sense-and-response) systems, among other technologies now in place or to be created.

While the invention has been described with reference to certain examples, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular example disclosed, but that the invention will include all examples falling within the scope of the appended claims.

What is claimed is:

1. An integrated system to facilitate collaboration, said system comprising:
a system for communicatively connecting real world elements and virtual world elements;
a system for simultaneously displaying said real world elements and said virtual world elements to at least two people remotely located from each other; and
a system for enabling said at least two people to interact with said displayed virtual world elements to manipulate said displayed virtual world elements in real time.

2. The system according to claim 1, wherein the system for communicatively connecting real world elements and virtual world elements comprises a unit having a plurality of displays and user interface panels, wherein at least one display and/or user interface panel is used to display or control real world elements and at least one display and/or user interface panel is used to display or control virtual world elements.

3. The system according to claim 2, wherein the plurality of displays and user interface panels include at least one upper level display and user interface panels, and at least one lower level display and user interface panels.

4. The system according to claim 3, wherein the at least one upper or lower level displays and user interface panels may be used for displaying real world elements selected from the group consisting of one or more team members at one or more sites, video data, audio data, sensor data or combinations thereof, and virtual world elements selected from the group consisting of one or more virtual team members, documents, models, simulations or combinations thereof.

5. The system according to claim 2, wherein the at least one user interface panel enables manipulation and addition of information on the plurality of displays by team members.

6. The system according to claim 2, wherein the system for communicatively connecting real world elements and virtual world elements further comprises one or more microphones or other speech detecting system to detect speech or other sound or audio sources.

7. The system according to claim 2, wherein the unit is formed in a free-standing configuration having the plurality of displays and user interface panels formed in a cylindrical type of configuration, with the unit being rotatable, and further comprising a processor engine, and a 360 degree camera to capture and project images of the at least two people in substantially real-time.

8. The system according to claim 2, wherein the unit is voice-activated, allowing hands free operation of selecting information displayed on the at least one display and/or control of the at least one user interface.

9. The system according to claim 2, wherein the unit is formed in flat configuration having the plurality of displays and user interface panels, with the unit being mountable to a wall, and further comprising a processor engine, and a 180 degree camera to capture and project images of the at least two people in substantially real-time.

10. The system according to claim 2, wherein the unit comprises a processor engine having an architecture that supports both generic collaborative processes along with task specific team processes instantiated through modular technologies selected from the group consisting of sensor data, human data, context-driven data including visual, audio, verbal, numerical, and alphanumerical data, and combinations thereof.

11. The system according to claim 2, wherein the unit comprises a processor engine having an architecture including group support software to manage interaction between the at least two people.

12. The system according to claim 2, wherein the unit comprises a processor engine having an architecture to provide assimilation of virtual world elements into collaboration tools and provide a mechanism to add content, expertise, and virtual or replacement team members.

13. The system according to claim 2, wherein the unit comprises a processor engine having an architecture to provide integrated capabilities and/or real-time capabilities to connect the virtual and physical worlds/environments including gathering data and integrating information and expertise from the at least two people when the at least two people are separated by geographical location and/or temporal fragmentation.

14. The system according to claim 2, wherein the unit comprises a processor engine having an architecture to provide data collection, data distribution, data visualization, data manipulation via remote networked sensors, embedded sensors, discrete sensors, visual simulations, voice/sound recognition, and combinations thereof.

15. The system according to claim 2, wherein the unit comprises a processor engine having an architecture to allow interaction between the at least two people synchronously or asynchronously.

16. The system according to claim 2, wherein the unit is in communication with one or more wireless communication systems and sensor systems comprising microphones, cameras, monitoring systems, and allows interface therewith to monitor locations and interface with appliances and electronic devices at the location.

17. The system according to claim 16, wherein the interface is a speech interface to allow control the appliances and/or electronic devices using voice commands and/or allowing command and control speech recognition functions, automatic monitoring or transcription or data capture.

18. The system according to claim 1, wherein the system for communicatively connecting real world elements and virtual world elements visual includes a simulation capability integrating substantially real-time data acquired from at least one sensor systems, wherein a processor engine receives data from the at least one sensor system and provides data distribution, data acquisition, and data visualization functions, and includes a database server having at least one publish-and-subscribe service library, wherein data acquired from the at least one sensor system is combined with data from the at least one publish-and-subscribe service library to substantially maintain an accurate representation or world model of elements that compose the environment in which said at least one sensor system is situated.

19. The system according to claim 18, wherein the at least one publish-and-subscribe library allows other applications to synchronously and concurrently receive update notifications and query information about the representation or world model, and a data acquisition system is designed to gather data from predetermined sources and publish the information to the database server.

20. The system according to claim 19, wherein the database server comprises database access stubs and at least one simulator.

21. The system according to claim 18 wherein a data visualization system includes applications that subscribe to the database server, and receive updates every time the state of the environment or world model changes, and presents the most current state of the environment to the at least two people.

22. The system according to claim 2, wherein the unit includes a processor including speech recognition software to perform at least one of the following tasks command-and-control, text-to-speech, dictation or combinations thereof.

23. The system according to claim 1, further comprising a processor engine and a plurality of e-sensors, wherein the plurality of e-sensors comprise computer software programs, data and information collection devices and communication interfaces, and wherein the e-sensors are designed for electronic collaboration, data-capture, information-sharing, monitoring and evaluating data and combinations thereof.

24. The system according to claim 23 wherein the plurality of e-sensors provide at least semi-automated analysis and action when at least one predetermined input is received.

25. The system according to claim 23 wherein the e-sensors gather predetermined data and monitor and evaluate the exchange in data and information between designated servers or networks.

26. The system according to claim 23 wherein the e-sensors are configured to signal at least one user when changes in the data monitored thereby are outside predetermined parameters.

27. A method to facilitate collaboration between at least two people at different locations, said method comprising:
communicatively connecting real world elements to virtual world elements;
simultaneously displaying said real world elements and said virtual world elements to at least two people remotely located from each other; and
enabling said at least two people to interact with said displayed virtual world elements to manipulate said displayed virtual world elements in real time.
